(19) United States
(12) Patent Application Publication
(10) Pub. No.: US 2025/0004157 A1
(43) Pub. Date: Jan. 2, 2025

(54) FILTERING METHODS AND ASSOCIATED UTILITY LOCATOR DEVICES FOR LOCATING AND MAPPING BURIED UTILITY LINES

(71) Applicant: SeeScan, Inc., San Diego, CA (US)

(72) Inventors: Mark S. Olsson, La Jolla, CA (US); Michael J. Martin, San Diego, CA (US)

(21) Appl. No.: 18/758,937

(22) Filed: Jun. 28, 2024

Related U.S. Application Data
(60) Provisional application No. 63/524,698, filed on Jul. 2, 2023.

(51) Int. Cl. G01V 3/08; G01C 21/16; G01S 19/14

(52) U.S. Cl. CPC G01V 3/081; G01C 21/16; G01S 19/14

(57) ABSTRACT

Various devices and methods are disclosed to efficiently determine and map the geolocations of utility lines. The devices and methods may, from measurements of electromagnetic signals of an area and the known geolocation of the utility locator device, map the geolocations of electromagnetic signals. Such maps may be generated from electromagnetic signal measurements at two or more measurement points and, in comparing the maps generated at two or more measurement points in space, determine the presence and geolocations of utility lines.

### CROSS-REFERENCE TO RELATED APPLICATIONS

This application claims priority under 35 U.S.C. § 119(e) to co-pending U.S. Provisional Patent Application Ser. No. 63/524,698, entitled FILTERING METHODS AND ASSOCIATED UTILITY LOCATOR DEVICES FOR LOCATING AND MAPPING BURIED UTILITY LINES, filed on Jul. 2, 2023, the content of which is hereby incorporated by reference herein in its entirety for all purpose.

### FIELD

This disclosure relates generally to methods and devices for identifying utility lines buried in the ground. More specifically, this disclosure relates to methods and devices for identifying and mapping utility lines buried in the ground via electromagnetic data across a range of frequencies.

### BACKGROUND

Utility locator devices used to locate utility lines buried or otherwise hidden from sight are known in the art. The vast majority of utility locator devices known in the art may measure electromagnetic signals at one or a limited few frequencies from current coupled to an electrically conductive utility line via a transmitter device or from AC current inherently flowing through the utility such as with a power line. Commonly, known utility locator devices may be tuned to one or a limited few frequencies emitted by a utility line which may be located via tracing the length of the utility line along the ground surface in a procedure commonly referred to as “line tracing.” As the majority of known utility locator devices are limited to one or few frequencies generally emitted by a singular utility line, a vast amount of electromagnetic data present in a locating environment that may relate to other buried utility lines is ignored and thus a user is provided a very limited understanding of the presence and locations of buried utility lines in the ground. Such a limited understanding of the presence and locations of buried utility lines may be extraordinarily dangerous wherein the excavation of an area containing utility lines is required. Every year a vast amount of costly damage is known to be caused by failing to locate utility lines prior to excavation. For instance, the failure to locate utility lines may often result in destruction to buildings and infrastructure as well as harm humans and even result in death from accidentally striking buried utility lines. Further, the vast number of utility locator devices may determine the location of one or more utility lines relative to the utility locator device but fail to further map the utility line location(s) relative to the world.

Very few electromagnetic utility locator devices known in the art are configured to measure electromagnetic data across a large range of frequencies. Those few utility locator devices capable of measuring electromagnetic data across a large range of frequencies tend to generate a vast amount of data. Whereas collecting such a larger amount of data may allow for a more complete understanding of utility lines present in an area, the vastness of the data tends to complicate the efficiency and effectiveness by which utility lines may be located. Such problems may further be complicated where positional data is also generated and correlated with electromagnetic data for the purpose of mapping utility lines.

Accordingly, there is a need in the art to address the above-described as well as other problems.

### SUMMARY

In accordance with one aspect of the present invention, a method for locating and mapping utility lines is disclosed. In one step, the method may include mapping the geolocations of electromagnetic signals measured from two or more points in space, referred to herein as “measurement points,” via a utility locator device. In another step, the method may include filtering out electromagnetic signals that have moved spatially in the maps of electromagnetic signals measured at the different measurement points. In another step, the method may include grouping electromagnetic signals based on electromagnetic signal patterns that are spatially linear. In yet another step, the method may further include identifying utility lines where electromagnetic signals fit a cylindrical magnetic field model.

In accordance with another aspect of the invention, a utility locating device may include one or more antennas and associated receiver circuitry to measure electromagnetic signals across a range of frequencies and determine the position of the source of the signal relative to the utility locator device. The utility locator device may further include a positioning element to determine a geolocation of the utility locator device. The utility locator device may further include a processing element having one or more processors to identify electromagnetic signals that conform to a cylindrical magnetic field model and align to be spatially linear and further remain stationary in the world frame when measured at two or more measurement points in determining and mapping utility lines. The utility locator device may further include a display element for communicating mapped utility lines to a user.

Various additional aspects, features, and functionality are further described below in conjunction with the appended Drawings.

### BRIEF DESCRIPTION OF THE DRAWINGS

The present application may be more fully appreciated in connection with the following detailed description taken in conjunction with the accompanying drawings, wherein:

FIG. 1 is an illustration of a prior art utility locating system;

FIG. 2 is a utility locator device of the present invention as used in a utility locating system;

FIG. 3 is a diagram of a utility locator device;

FIG. 4 is an illustration of exemplary antenna arrays;

FIG. 5 is a block diagram disclosing a method for utility locating and mapping;

FIG. 6 is an illustration of a utility locating device at spaced apart measurement points;

FIG. 7 is an illustration of a utility locating system of the present invention further including tagging of objects in the locate environment; and

FIG. 8 is a utility locating system having a utility locator device of the present disclosure further locating a pipe Sonde.

FIG. 9 is a method for providing Training Data to a Neural Network to use Deep Learning/artificial intelligence to recognize patterns and make predictions related to underground utilities via a vehicle-based locating system of the present invention.

FIG. 10 is a chart demonstrating various types of data, as an example, that may be used as Training Data for Deep Learning in a Neural Network that uses Artificial Intelligence (AI) in a vehicle-based locating system of the present invention.

### DETAILED DESCRIPTION OF EMBODIMENTS

### Overview

In accordance with one aspect of the present invention, a method for locating and mapping utility lines is disclosed. In one step, the method may include mapping the geolocations of electromagnetic signals measured from two or more points in space, also referred to herein as “measurement points,” via a utility locator device. For instance, determining the position of the electromagnetic signals includes calculating vectors each having a direction to the electromagnetic signal source and a magnitude indicating a distance relative to the utility locator device. The utility locator device may determine its geolocation (e.g., via GNSS and/or inertial navigation sensors) to further map the electromagnetic signals in the word frame. In another step, the method may include filtering out electromagnetic signals that have moved spatially in world frame maps of electromagnetic signals measured at the different measurement points. In another step, the method may include grouping electromagnetic signals based on electromagnetic signal patterns that are spatially linear. In yet another step, the method may further include identifying utility lines where electromagnetic signals fit a cylindrical magnetic field model. The method may optionally repeat mapping electromagnetic signals from additional geolocations.

In some embodiments, the methods may include filtering out non-spatially linear electromagnetic signal data where the magnitude of an electromagnetic signal falls beneath a predetermined threshold.

In another aspect, the distance between measurement points in space may be at a distance equal to or greater than the distance between measurement points and a utility line.

In another aspect, method embodiments may include identifying, via user input, other objects present in the locate environment. For instance, in some embodiments such objects may be associated with electromagnetic signals the do not move in the world frame between measurement points as measured by a utility locator device, are not spatially linear, or otherwise fail to conform to a cylindrical field model. In some embodiments, identifying of such objects in the utility locating environment may be achieved by electronically tagging objects with a rangefinder apparatus. In yet other embodiments, identifying of such objects in the utility locating environment may be achieved by identifying various electromagnetic signal attributes or electromagnetic signature.

In another aspect, method embodiments in keeping with the present disclosure may include identifying and determining the geolocation of a pipe Sonde and/or other dipole beacon by the utility locator device.

In another aspect, method embodiments may be processed on a utility locator device in real-time or near real-time. Likewise, in some embodiments, processing may occur in a remote database (e.g., cloud server or the like).

In another aspect of the invention, a utility locating device may include one or more antennas and associated receiver circuitry to measure electromagnetic signals across a range of frequencies and determine the position of the source of the signal relative to the utility locator device. In some embodiments, a utility locator device may include twelve antennas arranged in a dodecahedral array. The utility locator device may further include a positioning element to determine a geolocation of the utility locator device. The positioning element may be or include one or more GNSS receivers and antennas (e.g., GPS, Galileo, GLONASS, BeiDou, or the like) in generating a geolocation for the utility locator device. Likewise, the positioning element may include one or more inertial sensors (e.g., one or more accelerometers, gyroscopic sensors, compasses or other magnetometers, and the like) in determining movements of the utility locator device as well as the pose and orientation of the utility locator device at geolocations. The utility locator device may further include a processing element having one or more processors to identify electromagnetic signals that conform to a cylindrical magnetic field model and align to be spatially linear and further remain stationary in the world frame when measured at two or more measurement points in determining and mapping utility lines. The utility locator device may further include a display element for communicating mapped utility lines to a user.

In some embodiments, the utility locator device may include or may be in communication with a rangefinder apparatus for tagging objects in the locating environment. In some embodiments, the rangefinder apparatus may be built into the utility locator device. In other embodiments, a rangefinder apparatus may be a separate device communicatively coupled with the utility locator device.

In some embodiments, the utility locator device may include a radio apparatus in communicating with one or more external devices. In some such devices, data regarding mapping of utility lines determined by the utility locator device may be communicated with a remote database.

Details of example devices, systems, and methods that may be used in or combined with the invention disclosed herein, are disclosed in co-assigned patents and patent applications including: U.S. Pat. No. 5,808,239, issued Aug. 17, 1999, entitled VIDEO PUSH-CABLE; U.S. Pat. No. 6,545,704, issued Jul. 7, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,958,767, issued Oct. 25, 2005, entitled VIDEO PIPE INSPECTION SYSTEM EMPLOYING NON-ROTATING CABLE STORAGE DRUM; U.S. Pat. No. 6,862,945, issued Mar. 8, 2005, entitled CAMERA GUIDE FOR VIDEO PIPE INSPECTION SYSTEM; U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued Jan. 4, 2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,289,385, issued Oct. 16, 2012, entitled PUSH-CABLE FOR PIPE INSPECTION SYSTEM; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,395,661, issued Mar. 12, 2013, entitled PIPE INSPECTION SYSTEM WITH SELECTIVE IMAGE CAPTURE; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUSLY INDICATING THE DIFFERENT LOCATIONS TO A USER; U.S. Pat. No. 8,587,648, issued Nov. 19, 2013, entitled SELF-LEVELING CAMERA HEAD; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 8,908,027, issued Dec. 9, 2014, entitled ASYMMETRIC DRAG FORCE BEARING FOR USE WITH A PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. Pat. No. 8,984,698, issued Mar. 24, 2015, entitled LIGHT WEIGHT SEWER CABLE; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,081,109, issued Jul. 14, 2015, entitled GROUND-TRACKING DEVICES FOR USE WITH A MAPPING LOCATOR; U.S. Pat. No. 9,080,992, issued Jul. 14, 2015, entitled ADJUSTABLE VARIABLE RESOLUTION INSPECTION SYSTEMS AND METHODS; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,222,809, issued Dec. 29, 2015, entitled PORTABLE PIPE INSPECTION SYSTEMS AND APPARATUS; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPARATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,465,129, issued Oct. 11, 2016, entitled IMAGE-BASED MAPPING LOCATING SYSTEM; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,521,303, issued Dec. 13, 2016, entitled CABLE STORAGE DRUM WITH MOVABLE CCU DOCKING APPARATUS; U.S. patent application Ser. No. 15/846,102, filed Dec. 16, 2016, entitled SYSTEMS AND METHODS FOR ELECTRONICALLY MARKING, LOCATING AND VIRTUALLY DISPLAYING BURIED UTILITIES; U.S. patent application Ser. No. 15/866,360, filed Jan. 9, 2017, entitled TRACKABLE DISTANCE MEASURING DEVICES, SYSTEMS, AND METHODS; U.S. Pat. No. 9,927,368, issued Mar. 27, 2021, entitled SELF-LEVELING INSPECTION SYSTEMS AND METHODS; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); United States Patent Application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; United States Patent Application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,769,366, issued Sep. 29, 2017, entitled SELF-GROUNDING TRANSMITTER PORTABLE CAMERA CONTROLLER FOR USE WITH PIPE INSPECTION SYSTEMS; U.S. Pat. No. 9,784,837, issued Oct. 10, 2017, entitled OPTICAL GROUND TRACKING APPARATUS, SYSTEMS & METHODS; U.S. Pat. No. 9,798,033, issued Oct. 24, 2017, entitled SONDE DEVICES INCLUDING A SECTIONAL FERRITE CORE; U.S. patent application Ser. No. 15/811,361, filed Nov. 13, 2017, entitled OPTICAL GROUND-TRACKING APPARATUS, SYSTEMS, AND METHODS; U.S. Pat. No. 9,835,564, issued Dec. 5, 2017, entitled MULTI-CAMERA PIPE INSPECTION APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. patent application Ser. No. 16/255,524, filed Jan. 23, 2018, entitled RECHARGEABLE BATTERY PACK ONBOARD CHARGE STATE INDICATION METHODS AND APPARATUS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 2018, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 16/382,136, filed Apr. 11, 2018, entitled GEOGRAPHIC MAP UPDATING METHODS AND SYSTEMS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,959,641, issued May 1, 2018, entitled METHODS AND SYSTEMS FOR SEAMLESS TRANSITIONING IN INTERACTIVE MAPPING SYSTEMS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORTHOGONAL ANTENNAE; U.S. patent application Ser. No. 16/443,789, filed Jun. 18, 2018, entitled MULTI-DIELECTRIC COAXIAL PUSH-CABLES AND ASSOCIATED APPARATUS; U.S. Pat. No. 10,001,425, issued Jun. 19, 2018, entitled PORTABLE CAMERA CONTROLLER PLATFORM FOR USE WITH PIPE INSPECTION SYSTEM; U.S. Pat. No. 10,009,582, issued Jun. 26, 2018, entitled PIPE INSPECTION SYSTEM WITH REPLACEABLE CABLE STORAGE DRUM; U.S. patent application Ser. No. 16/036,713, issued Jul. 16, 2018, entitled UTILITY LOCATOR APPARATUS AND SYSTEMS; U.S. Pat. No. 10,027,526, issued Jul. 17, 2018, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. Pat. No. 10,100,507, issued Oct. 16, 2018, entitled PIPE CLEARING CABLES AND APPARATUS; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. patent application Ser. No. 16/810,788, filed Mar. 5, 2019, entitled MAGNETICALLY RETAINED DEVICE HANDLES; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. Pat. No. 10,288,997, issued May 14, 2019, entitled ROTATING CONTACT ASSEMBLIES FOR SELF-LEVELING CAMERA HEADS; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. Pat. No. 10,371,305, issued Aug. 6, 2019, entitled DOCKABLE TRIPODAL CAMERA CONTROL UNIT; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. patent application Ser. No. 16/559,576, filed Sep. 3, 2019, entitled VIDEO PIPE INSPECTION SYSTEMS WITH VIDEO INTEGRATED WITH ADDITIONAL SENSOR DATA; U.S. patent application Ser. No. 16/588,834, filed Sep. 30, 2019, entitled VIDEO INSPECTION SYSTEM WITH WIRELESS ENABLED CABLE STORAGE DRUM; U.S. Pat. No. 10,440,332, issued Oct. 8, 2019, entitled INSPECTION CAMERA DEVICES AND METHODS WITH SELECTIVELY ILLUMINATED MULTISENSOR IMAGING; U.S. patent application Ser. No. 16/676,292, filed Nov. 6, 2019, entitled ROBUST IMPEDANCE CONTROLLED SLIP RINGS; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. patent application Ser. No. 17/397,940, filed Aug. 9, 2021, entitled INSPECTION SYSTEM PUSH-CABLE GUIDE APPARATUS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTLITITY LOCATOR INCLUDING A CAMERA; U.S. patent Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/013,831, filed Sep. 7, 2020, entitled MULTIFUNCTION BURIED UTILITY LOCATING CLIPS; U.S. patent application Ser. No. 17/014,646, filed Sep. 8, 2020, entitled INTEGRATED FLEX-SHAFT CAMERA SYSTEM AND HAND CONTROL; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,848,655, issued Nov. 24, 2020, entitled HEAT EXTRACTION ARCHITECTURE FOR COMPACT VIDEO CAMERA HEADS; U.S. patent application Ser. No. 17/110,273, filed Dec. 2, 2020, entitled INTEGRAL DUAL CLEANER CAMERA DRUM SYSTEMS AND METHODS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; U.S. patent application Ser. No. 17/190,400, filed Mar. 3, 2021, entitled DOCKABLE CAMERA REEL AND CCU SYSTEM; U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,956, filed Nov. 17, 2021, entitled VIDEO INSPECTION SYSTEM, APPARATUS, AND METHODS WITH RELAY MODULES AND CONNECTION PORT; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM, APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. patent application Ser. No. 17/563,049, filed Dec. 28, 2021, entitled SONDE DEVICES WITH A SECTIONAL FERRITE CORE; U.S. patent application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILITY LOCATING SYSTEMS AND METHODS WITH FILTER TUNING FOR POWER GRID FLUCTUATIONS; U.S. Pat. No. 11,614,613, issued Mar. 28, 2023, entitled DOCKABLE CAMERA REEL AND CCU SYSTEM; U.S. Pat. No. 11,649,917, issued May 16, 2023, entitled INTEGRATED FLEX-SHAFT CAMERA SYSTEM WITH HAND CONTROL; U.S. Pat. No. 11,665,321, issued May 30, 2023, entitled PIPE INSPECTION SYSTEM WITH REPLACEABLE CABLE STORAGE DRUM; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,686,878, issued Jun. 27, 2023, entitled ELECTRONIC MARKER DEVICES FOR BURIED OR HIDDEN USE; U.S. Provisional Patent Application 63/524,698, filed Jul. 2, 2023, entitled FILTERING METHODS AND ASSOCIATED UTILITY LOCATOR DEVICES FOR LOCATING AND MAPPING BURIED UTILITY LINES; U.S. Provisional Patent Application 63/514,090, filed Jul. 17, 2023, entitled SMARTPHONE MAPPING APPARATUS FOR ASET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,646, issued Aug. 8, 2023, entitled PIPE MAPPING SYSTEMS AND METHODS; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; U.S. Provisional patent application Ser. No. 18/490,763, filed Oct. 20, 2023, entitled LINKED CABLE-HANDLING AND CABLE-STORAGE DRUM DEVICES AND SYSTEMS FOR COORDINATED MOVEMENT OF PUSH-CABLE; U.S. Pat. No. 11,796,707, issued Oct. 24, 2023, entitled USER INTERFACES FOR UTILITY LOCATORS; U.S. patent application Ser. No. 18/544,042, filed Dec. 18, 2023, entitled SYSTEMS, APPARATUS, AND METHODS FOR DOCUMENTING UTILITY POTHOLES AND ASSOCIATED UTILITY LINES; U.S. Pat. No. 11,876,283, issued Jan. 16, 2024, entitled COMBINED SATELLITE NAVIGATION AND RADIO TRANSCEIVER ANTENNA DEVICES; U.S. Pat. No. 11,894,707, issued Feb. 6, 2024, entitled RECHARGEABLE BATTERY PACK ONBOARD CHARGE STATE INDICATION METHODS AND APPARATUS; U.S. Pat. No. 11,909,104, issued Feb. 20, 2024, entitled ANTENNAS, MULTI-ANTENNA APPARATUS, AND ANTENNA HOUSINGS; U.S. Provisional Patent Application 63/558,098, filed Feb. 26, 2024, entitled SYSTEMS, DEVICES, AND METHODS FOR DOCUMENTING GROUND ASSETS AND ASSOCIATED UTILITY LINES; U.S. Pat. No. 11,921,225, issued Mar. 5, 2024, entitled ANTENNA SYSTEMS FOR CIRCULARLY POLARIZED RADIO SIGNALS; U.S. patent application Ser. No. 18/611,449, filed Mar. 20, 2024, entitled VIDEO INSPECTION AND CAMERA HEAD TRACKING SYSTEMS AND METHODS; U.S. Pat. No. 11,953,643, issued Apr. 9, 2024, entitled MAP GENERATION BASED ON UTILITY LINE POSITION AND ORIENTATION ESTIMATES; U.S. Provisional Patent 63/643,915, filed May 7, 2024, entitled SYSTEMS AND METHODS FOR LOCATING AND MAPPING BURIED UTILITY OBJECTS USING ARTIFICIAL INTELLIGENCE WITH LOCAL OR REMOTE PROCESSING; and U.S. Provisional Patent 63/659,722, filed Jun. 13, 2024, entitled VEHICLE-MOUNTING DEVICES AND METHODS FOR USE IN VEHICLE-BASED LOCATING SYSTEMS. The content of each of the above-described patents and applications is incorporated by reference herein in its entirety. The above applications may be collectively denoted herein as the “co-assigned applications” or “incorporated applications.”

The following exemplary embodiments are provided for the purpose of illustrating examples of various aspects, details, and functions of apparatus and systems; however, the described embodiments are not intended to be in any way limiting. It will be apparent to one of ordinary skill in the art that various aspects may be implemented in other embodiments within the spirit and scope of the present disclosure.

It is noted that as used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Terminology

As used herein, the term “position” may refer to a location or geolocation as well as a pose or orientation in three dimensions at that location. For instance, a geolocation determined by GNSS may further include a pose or orientation at the geolocation determined via one or more inertial sensors (e.g., accelerometers, gyroscopic sensors, magnetometers, and the like). Further, the INS may include one or more barometers.

The term “world frame” may refer to a frame of reference relative to the world. In general, the term “world frame” may refer to geolocations relative to the Earth's surface (e.g., GNSS coordinates or the like). The geolocations determined in the world frame may be in contrast to positions in the “local frame” or that relative to the utility locator device.

The term “electromagnetic signals” or “signals” as used herein may refer to the radiation of electromagnetic energy, and in particular to the associated magnetic field vectors. Such electromagnetic signals may be from current coupled to a conductive utility line, current inherently flowing through a utility line (e.g., power line), the re-radiation of electromagnetic energy (e.g., broadcast radio signals or the like), and other radiation of electromagnetic energy from other sources that may be measured via a utility locator device. The methods and devices of the present invention may identify electromagnetic signals having a cylindrical field in identifying utility lines versus other electromagnetic signals having other field shapes.

The term “measurement point” may refer to a point in space or geolocation of the utility locator device where electromagnetic signals may be measured and mapped. The methods and devices of the present disclosure may measure and map electromagnetic signals at two or more measurement points and compare maps of the electromagnetic signals.

As used herein, the term “map” refers to imagery, diagrams, graphical illustrations, line drawings or other representations depicting the attributes of a location, which may include maps or images containing various dimensions (i.e. two-dimensional maps or images and/or three-dimensional maps or images). These may be vector or raster objects and/or combinations of both. Such depictions and/or representations may be used for navigation and/or relaying information associated with positions or locations and may also contain information associated with the positions or locations such as coordinates, information defining features, images or video depictions, and/or other related data or information. For instance, the spatial positioning of ground surface attributes may be depicted through a series of photographs or line drawings or other graphics representing a location. Various other data may be embedded or otherwise included into maps including, but not limited to, reference coordinate information, such as latitude, longitude, and/or altitude data, topographical information, virtual models/objects, information regarding buried utilities or other associated objects or elements, structures on or below the surface, and the like. The methods and devices of the present invention may map electromagnetic signals and compare the maps of electromagnetic signals in determining the presence and mapping utility lines.

The term “linear” in relation to mapped electromagnetic signals and associated utility lines may refer to being substantially straight. It should be understood that the linear mapped electromagnetic signals and utility lines may not be infinitely linear and may include tee junctions, bends, and other deviation from straight lines and that “linear” used herein may instead refer to sections that are linear.

The term “cylindrical field” refers to the shape of a magnetic field that may be emitted by a conductive utility line or other cylindrical object, for instance, where AC electrical current is coupled thereto. Further, the term “cylindrical field model” refers to models of electromagnetic energy having a cylindrical field. The electromagnetic signals conforming to a cylindrical field model as discussed herein may, in part, be used to identify utility lines. Whereas the utility locator devices of the present invention may generally identify utility lines based on non-moving electromagnetic fields that conform to a cylindrical field model, the utility locator devices of the present invention may likewise measure other shaped electromagnetic signals. In particular, the utility locator devices of the present invention may measure dipole electromagnetic signals such as those emitted by pipe Sondes and other like beacons.

### EXAMPLE EMBODIMENTS

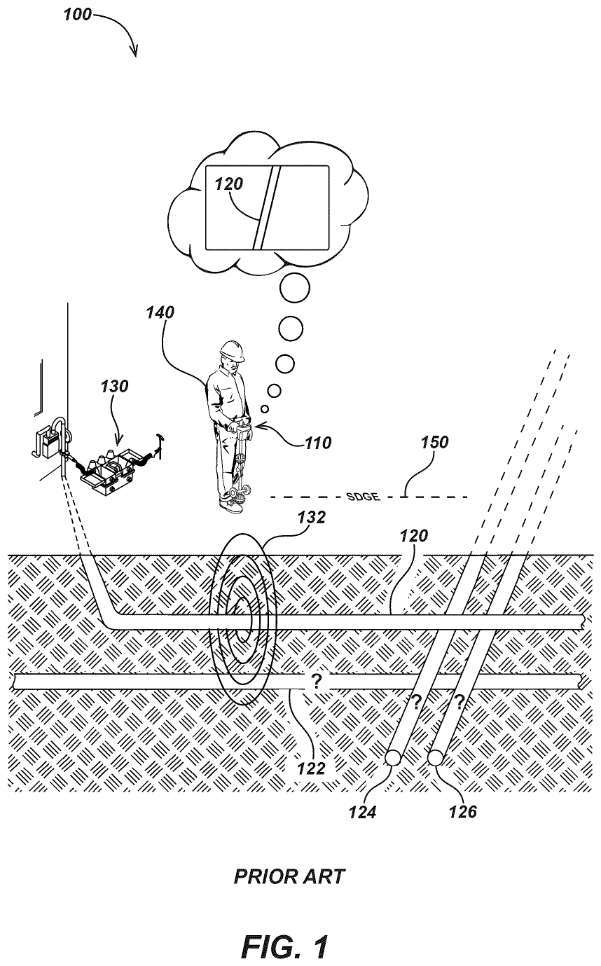

In FIG. 1, a prior art utility locating system 100 is illustrated that includes a prior art utility locating device 110 for locating buried utility lines such as a utility line 120. In the prior art system 100 of FIG. 1, the location of the utility line 120 may be determined via the utility locator device 110 measuring an electromagnetic signal 132 emitted from the utility line 120. For instance, a transmitter device 130 may couple AC current to the utility line 120 causing the utility line 120 to emit the electromagnetic signal 132. The utility locator device 110 may be tuned to the frequency or frequencies of the electromagnetic signal 132 allowing a user 140 equipped with the utility locator device 110 to line trace the utility line 120 along the ground surface. In order to indicate the position of the utility line 120 for future excavation or other use, the user 140 may optionally generate one or more paint markings 150 on the ground surface. As paint may fade or disappear over time, such a solution to locate the utility line 120 at the ground surface is temporary. Likewise, as the locating environment may contain a plurality of other utility lines (e.g., a gas line 122, a water line 124, or a power line 126), the line tracing operation used to locate the utility line 120 may fail to determine the presence of other utility lines. As a consequence, the excavation of an area may be hazardous where there is a lack of knowledge concerning all buried utility lines that may be in or near excavation area. For instance, if the locating area illustrated in FIG. 1 were to be excavated with the knowledge of the utility line 120 position but without knowing about the presence of the gas line 122, the water line 124, or the power line 126, the user may risk striking the gas line 122 and possibly causing an explosion, the water line 124 and causing a flood, or the power line 126 and risk electrocution and/or causing a fire.

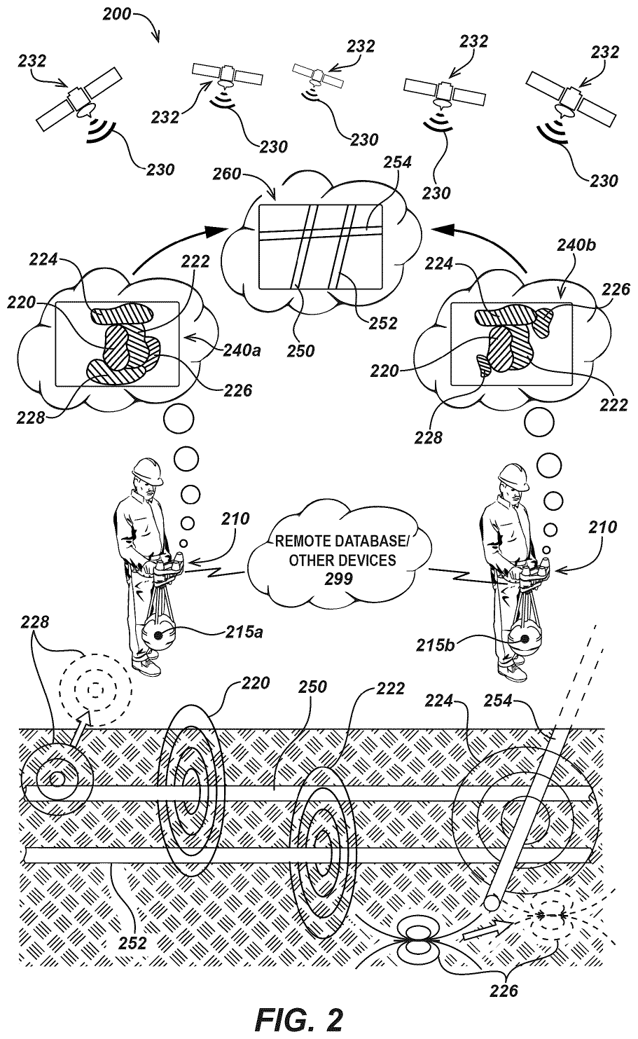

Turning to FIG. 2, a utility locating system 200 is illustrated that includes a utility locator device 210 of the present invention that may solve the problems of the prior art system 100 of FIG. 1. As illustrated, the utility locator device 210 may measure a range of frequencies of electromagnetic signals (e.g., an electromagnetic signal 220, 222, 224, 226, and 228) present in the locate area relative to the utility locator device 210 at two or more measurement points in space (e.g., a measurement point 215a and a measurement point 215b). For instance, the utility locator device 210 may measure from 50 Hz to 148,208 Hz or other range of frequencies that may generally cover signals present in a locate environment in order to provide a reasonably complete understanding of the presence or absence and geolocations of utility lines. The utility locator device 210 may be or share aspects with the utility locator devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 29/692,937, filed May 29, 2019, entitled BURIED OBJECT LOCATOR; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; United States Patent Application D922,885, issued Jun. 22, 2021, entitled BURIED OBJECT LOCATOR; U.S. Pat. No. 11,196,181, issued Dec. 7, 2021, entitled LOW COST, HIGH PERFORMANCE SIGNAL PROCESSING IN A MAGNETIC-FIELD SENSING BURIED UTILITY LOCATOR SYSTEM; and/or others disclosed in the incorporated patents and applications. The content of each of these applications is incorporated by reference herein in its entirety.

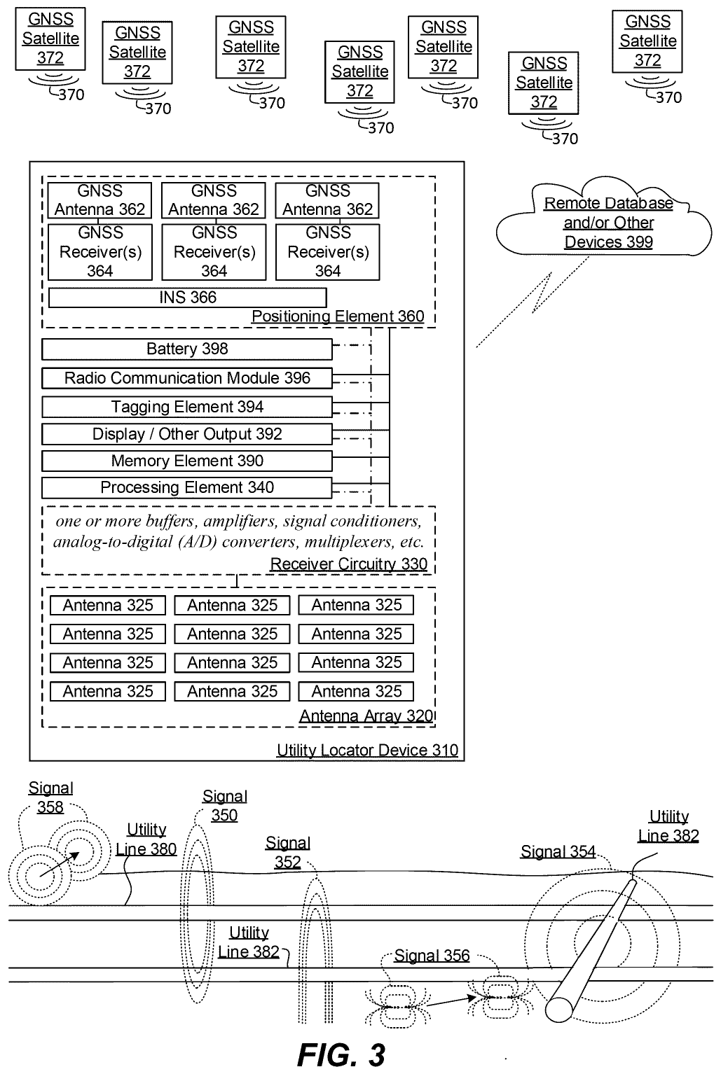

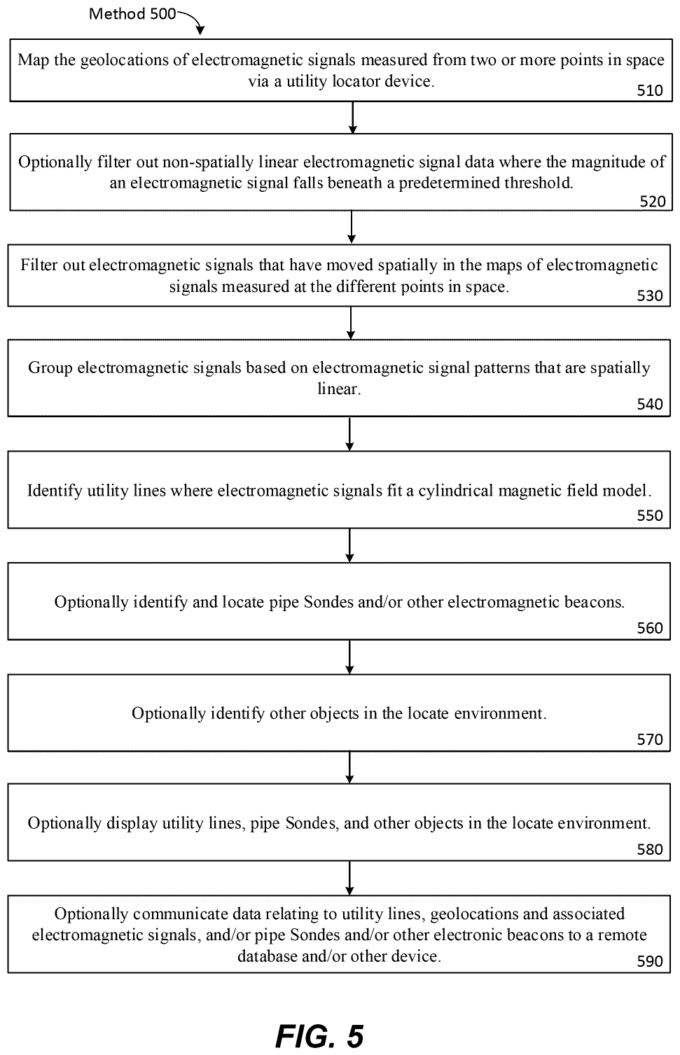

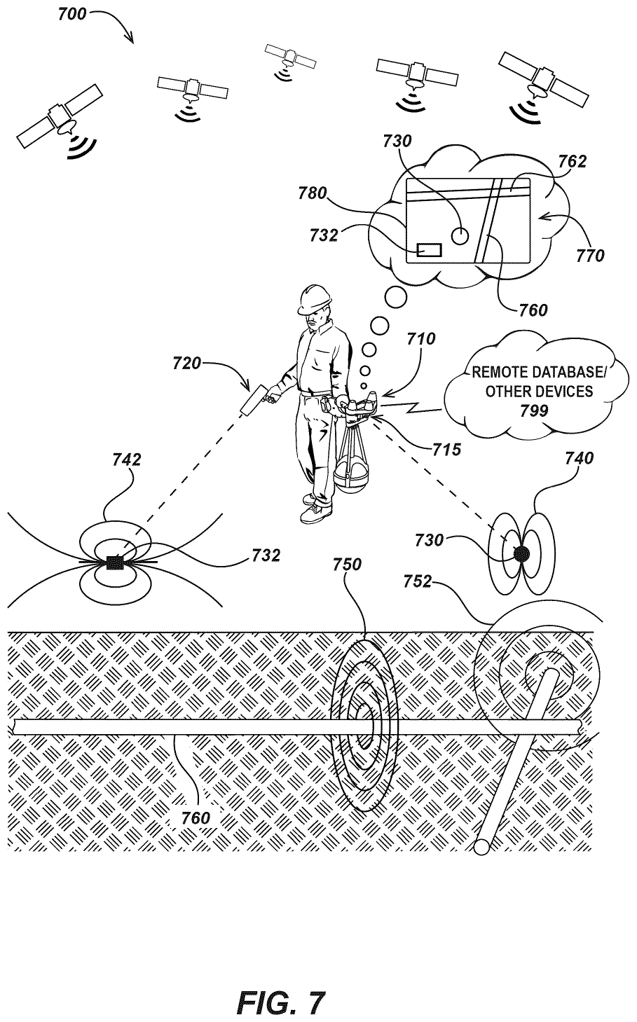

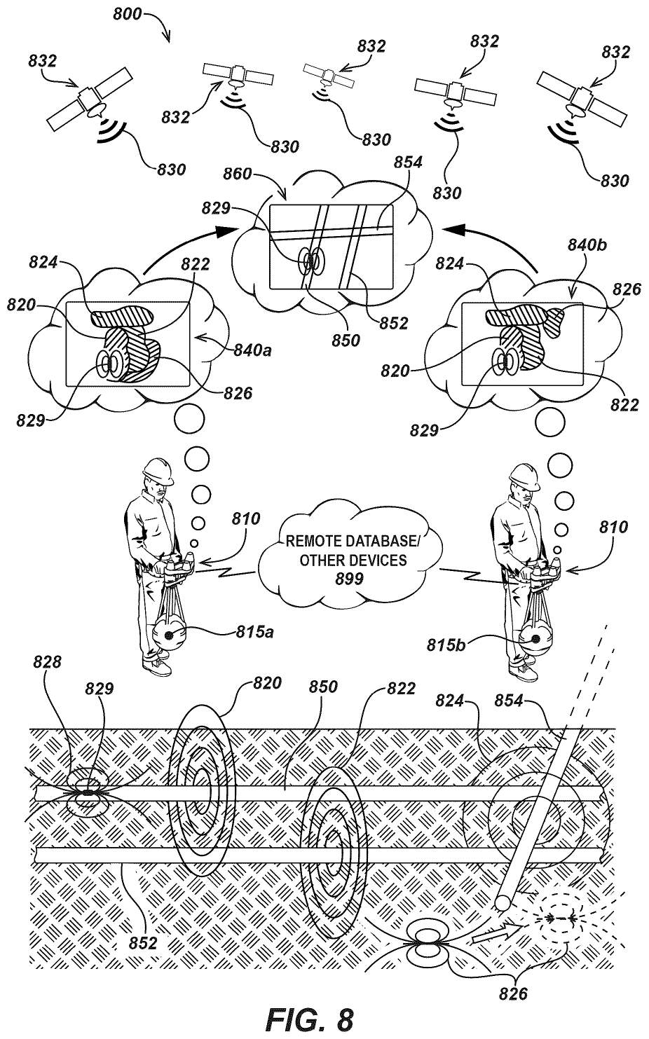

Still referring to FIG. 2, it should be noted that the electromagnetic signals 220, 222, 224, and 228 conform to a cylindrical field model whereas the electromagnetic signal 226 may be a dipole or have a different field shape. Further, it should also be noted that the electromagnetic signals 226 and 228 are illustrated as moving spatially in the world frame. From the measured electromagnetic signals 220, 222, 224, 226, and 228 and a known geolocation determined via one or more GNSS signals 230 from a plurality of GNSS satellites 232 and/or INS (e.g., an INS 366 of FIG. 3) and/or other positioning element, a map 240a and a map 240b may be generated mapping the measured electromagnetic signals 220, 222, 224, 226, and 228 to geolocations in the world frame from each measurement point 215a and 215b respectively. For instance, the maps 240a and 240b may group each measured electromagnetic signals 220, 222, 224, 226, and 228 based on a similarity in depth measurement. In other embodiments, such a grouping may instead or additionally be based on frequency and/or other attributes of the measured electromagnetic signals 220, 222, 224, 226, and 228. The maps 240a and 240b may further be refined via the methods of the present disclosure (e.g., the method 500 of FIG. 5) in generating a map 260 indicating the geolocation of a plurality of utility lines 250, 252, and 254 in the locate area. For instance, the map 260 may result from identifying those electromagnetic signals 220, 222, and 224 from the electromagnetic signals 220, 222, 224, 226, and 228 that have not moved spatially between the maps 240a and 240b, are substantially linear in the maps 240a and 240b, and conform to a cylindrical field model. For instance, the electromagnetic signals 226 and 228 may move between the map 240a and the map 240b and therefore may be excluded in the map 260 that may be displayed on the utility locator device 210. Likewise, the signals 226 is illustrated as having a field shape that does not conform to a cylindrical field model and therefore may also be excluded in the map 260 that may be displayed on the utility locator device 210. In some embodiments, objects associated with electromagnetic signals having field shapes that do not conform to a cylindrical field model but may not move may be identified and mapped as disclosed in the method 500 in FIG. 5 as well as with the system illustrated in FIGS. 7 and 8. In some embodiments, a dipole signal may, for instance, be from a pipe Sonde or other electromagnetic beacon and a utility locator device may locate and map the position and geolocation of such a pipe Sonde or other electromagnetic beacon such as an electronic marker device.

Such a pipe Sonde may be or share aspects with those disclosed in U.S. Pat. No. 7,009,399, issued Mar. 7, 2006, entitled OMNIDIRECTIONAL SONDE AND LINE LOCATOR; U.S. Pat. No. 7,221,136, issued May 22, 2007, entitled SONDES FOR LOCATING UNDERGROUND PIPES AND CONDUITS; U.S. Pat. No. 7,298,126, issued Nov. 20, 2007, entitled SONDES FOR LOCATING UNDERGROUND PIPES AND CONDUITS; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,816, issued Mar. 3, 2009, entitled OMNIDIRECTIONAL SONDE AND LINE LOCATOR; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,864,980, issued Jan. 4, 2011, entitled SONDES FOR LOCATING UNDERGROUND PIPES AND CONDUITS; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. patent application Ser. No. 14/027,027, filed Sep. 13, 2013, entitled SONDE DEVICES INCLUDING A SECTIONAL FERRITE CORE STRUCTURE; U.S. Pat. No. 9,411,066, issued Aug. 9, 2016, entitled SONDES & METHODS FOR USE WITH BURIED LINE LOCATOR SYSTEMS; U.S. Pat. No. 9,798,033, issued Oct. 24, 2017, entitled SONDE DEVICES INCLUDING A SECTIONAL FERRITE CORE; U.S. patent application Ser. No. 16/792,047, filed Feb. 14, 2020, entitled SATELLITE AND MAGNETIC FIELD SONDE APPARATUS AND METHODS; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,761,233, issued Sep. 1, 2020, entitled SONDES AND METHODS FOR USE WITH BURIED LINE LOCATOR SYSTEMS; U.S. Pat. No. 11,119,238, issued Sep. 14, 2021, entitled SATELLITE AND MAGNETIC FIELD SONDE APPARATUS AND METHODS; U.S. patent application Ser. No. 17/563,049, filed Dec. 28, 2021, entitled SONDE DEVICES WITH A SECTIONAL FERRITE CORE; U.S. Pat. No. 11,709,289, issued Jul. 25, 2023, entitled SONDE DEVICES WITH A SECTIONAL FERRITE CORE; and/or others disclosed in the incorporated patents and applications. The content of each of these applications is incorporated by reference herein in its entirety.

Likewise, the other electromagnetic beacons may be or share aspects with the marker devices disclosed in U.S. patent application Ser. No. 15/681,250, filed Aug. 18, 2017, entitled ELECTRONIC MARKER DEVICES AND SYSTEMS; U.S. Pat. No. 9,746,572, issued Aug. 29, 2017, entitled ELECTRONIC MARKER DEVICES AND SYSTEMS; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,859,727, issued Dec. 8, 2020, entitled ELECTRONIC MARKER DEVICES AND SYSTEMS; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/541,057, filed Dec. 2, 2021, entitled COLOR-INDEPENDENT MARKER DEVICE APPARATUS, METHODS, AND SYSTEMS; U.S. Pat. No. 11,280,934, issued Mar. 22, 2022, entitled ELECTROMAGNETIC MARKER DEVICES FOR BURIED OR HIDDEN USE; U.S. Pat. No. 11,333,786, issued May 17, 2022, entitled BURIED UTILITY MARKER DEVICE, SYSTEMS, AND METHODS; U.S. Pat. No. 11,467,317, issued Oct. 11, 2022, entitled ELECTROMAGNETIC MARKER DEVICES WITH SEPARATE RECEIVE AND TRANSMIT ANTENNA ELEMENTS; and/or others disclosed in the incorporated patents and applications. The content of each of these applications is incorporated by reference herein in its entirety.

Still referring to FIG. 2, the data relating to geolocations and associated electromagnetic signals (e.g., the electromagnetic signals 220, 222, 224, 226, and 228) may be processed via methods of the present invention (e.g., the method 500 of FIG. 5) in real-time or near real-time on the utility locator device 210. Optionally, the data relating to geolocations and associated electromagnetic signals (e.g., the electromagnetic signals 220, 222, 224, 226, and 228) may be communicated to a remote database and/or other device 299 (e.g., cloud server, laptops, smartphones, other utility locator devices, transmitter devices for coupling current on utility lines, and/or other system devices) which may be processed via methods of the present invention (e.g., the method 500 of FIG. 5) in post processing or in real-time or near real-time.

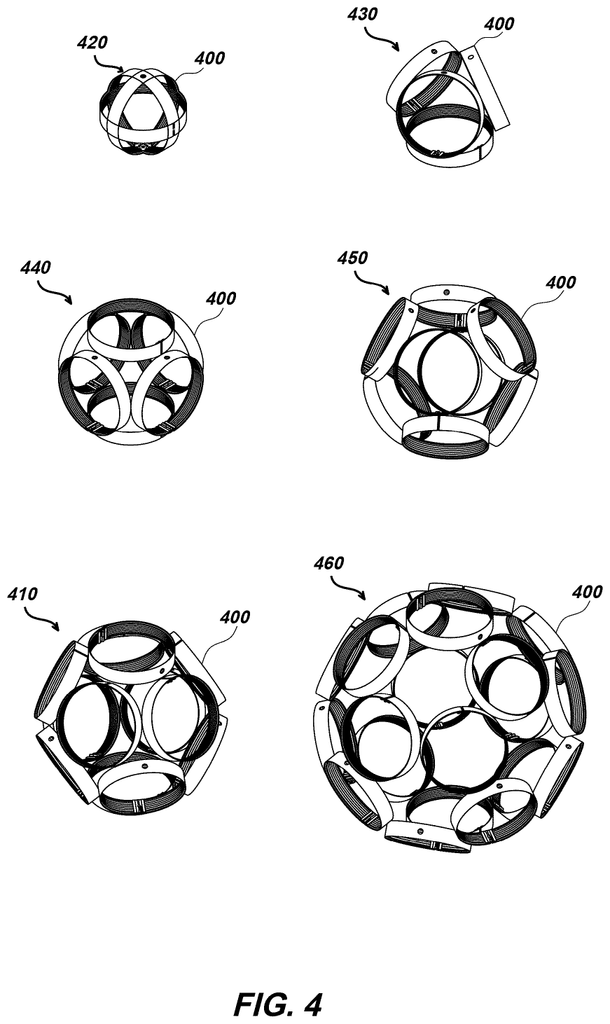

Turning to FIG. 3, a utility locator device 310 is diagramed which may be or share aspects with the utility locator device 210 of FIG. 2 or other utility locator devices of the present disclosure. The utility locator device 310 may include one or more antennas 325 and an associated receiver circuitry 330. The utility locator device 310 may have an antenna array 320 having a plurality of antennas 325. As illustrated in FIG. 3, the antenna array 320 may include twelve antennas 325 which may further be in a dodecahedral array (e.g., a dodecahedral array 410 of antennas 400 as illustrated in FIG. 4) or other array (e.g., an array 420, an array 430, and array 440, an array 450, an array 460 of FIG. 4, or other array configuration having other numbers of antennas) providing measurement of a plurality of electromagnetic signals 350, 352, 354, 356, and 358 in the locate environment. The antenna array 320 may be arranged such that measurement of the electromagnetic signals 350, 352, 354, 356, and 358 may result in the direction and distance to the electromagnetic signals 350, 352, 354, 356, and 358. It should be noted that the electromagnetic signals 350, 352, 354, and 358 conform to a cylindrical field model whereas the electromagnetic field 356 is a dipole signal. Further, the electromagnetic signals 350, 352, and 354 are stationary in the world frame whereas the electromagnetic signals 356 and 358 are illustrated as moving in the world frame.

The receiver circuitry 330 which may, for example, include one or more buffers, amplifiers, signal conditioners, analog-to-digital (A/D) converters, multiplexers, and the like to provide filtering functionality, signal conditioning, or the like for outputs to a processing element 340 having one or more processor to determine the emission positions of a plurality of electromagnetic signals, such as an electromagnetic signal 350, 352, 354, 356, and 358, relative to the utility locator device 310. For instance, a series vector may be determined from the electromagnetic signals 350, 352, 354, 356, and 358 having a direction and distance to electromagnetic signals 350, 352, 354, 356, and 358.

Still referring to FIG. 3, the utility locator device 310 may include a positioning element 360 in determining and outputting positioning data related to the geolocation and pose or orientation of the utility locator device 310. The positioning element 360 may include one or more GNSS antennas 362 and associated GNSS receivers 364 in receiving a plurality of GNSS signals 370 from a plurality of GNSS satellites 372 (e.g., GPS, Galileo, GLONASS, BeiDou, or the like) in determining geolocations of the utility locator device 310 in the world frame. Likewise, the positioning element 360 may include one or more inertial navigation sensors (INS) 366 in determining geolocations and pose or orientations of the utility locator device 310 at each geolocation. The INS 366 may, for example, be or include one or more accelerometers, gyroscopic sensors, compasses or other magnetometers, and/or the like. The processing element 360, in receiving the positioning data from the positioning element 360 and electromagnetic signals 350, 352, 354, 356, and 358, may map the electromagnetic signals 350, 352, 354, 356, and 358 geolocations (e.g., the maps 240a and 240b of FIG. 2) in the world frame. Further, the processing element 340 may, via the method 500 of FIG. 5 or other method embodiments in keeping with the present disclosure, determine the presence and geolocations of a plurality of utility lines 380, 382, and 384 where the electromagnetic signals 350, 352, 354, 356, and 358 are measured by the utility locator device 310 at two or more geolocations or measurement points in space. For instance, the electromagnetic signals 356 may be a dipole or have another field shape that does not conform to a cylindrical field model and may therefore be excluded as being emitted by utility lines. It should be noted, a dipole electromagnetic field or other field shape may, in some embodiments, be used to indicate other objects in the locate environment. For instance, other objects in the locate environment may be tagged or otherwise identified, as illustrated in FIG. 7. In some such embodiments, the tagged or otherwise identified objects may emit an electromagnetic signal that does not move between measurement points of the utility locator device but may not be associated with a utility line (e.g., is not spatially linear and/or has a field shape that does not conform to a cylindrical field model). Likewise, a dipole signal at one or more known frequencies may be from a pipe Sonde (e.g., the dipole signal 828 from the pipe Sonde 829 of FIG. 8). A utility locator device in keeping with the present invention may, in addition to determining and mapping utility lines via the methods disclosed herein (e.g., the method 500 of FIG. 5), determine and map the position of such a pipe Sonde from the dipole signal.

Still referring to FIG. 3, the electromagnetic signals 350, 352, 354, and 358 may conform to a cylindrical field model. Because the electromagnetic signal 358 may move in the world frame between two or more measurement points, the electromagnetic signal 358 may be excluded as being emitted from a utility line. In contrast, the electromagnetic signals 350, 352, 354 do not move in the world frame between two or more measurement points and may therefore be related to the utility lines 380, 382, and 384 respectively.

Still referring to FIG. 3, the utility locator device 310 may further include a memory element 390 having one or more non-transitory memories that may store data related to the electromagnetic signals (e.g., the electromagnetic signals 350, 352, 354, 356, and 358), geolocation data, and instructions related to the methods of the present disclosure. The utility locator device 310 may further include a display or other output (e.g., a display/other output 392). The display/other output 392 may communicate information related to the presence and geolocations of utility lines as well as related electromagnetic signal data and other device or system related data to a user. For instance, the display/other output 392 may include a graphical user interface to visually represent maps that include geolocations of utility lines (e.g., the map 260 of FIG. 2). Likewise, the display/other output 392 may include speakers to audibly communicate information related to the presence and geolocations of utility lines as well as related electromagnetic signal data and other device or system related data to a user. Further, the display/other output 392 may include haptic feedback mechanisms and/or other mechanisms in communicating information related to the presence and geolocations of utility lines as well as related electromagnetic signal data and other device or system related data to a user.

Still referring to FIG. 3, the utility locator device 310 may further include a tagging element 394 to identify and indicate information relating to objects in the locating environment. In some embodiments the tagging element 394 may be or include a laser rangefinder to point to objects of interest, such as those which may be associated with non-utility related electromagnetic signals (e.g., the electromagnetic signals 356 and 358), optionally photograph the object and/or identify the object, and record the geolocation of the object (e.g., a laser rangefinder apparatus 715 built into a utility locator device or a handheld laser rangefinder 720 of FIG. 7 in communication with the utility locator device 710). For instance, the tagging element 394 may be or share aspects with U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; U.S. Pat. No. 11,397,274, issued Jul. 26, 2022, entitled TRACKED DISTANCE MEASURING DEVICES, SYSTEMS, AND METHODS; and/or other devices disclosed in the incorporated patents and applications. The content of each of these applications is incorporated by reference herein in its entirety.

Still referring to FIG. 3, the utility locator device 310 may process the data relating to geolocations and associated electromagnetic signals (e.g., the electromagnetic signals 350, 352, 354, 356, and 358) via methods of the present invention (e.g., the method 500 of FIG. 5) in real-time or near real-time on the utility locator device 310. In some embodiments, the utility locator device 310 may further include a radio communication module 396 (e.g., via Bluetooth, Wi-Fi, ISM, or the like) to communicate data relating to geolocations and associated electromagnetic signals (e.g., the electromagnetic signals 350, 352, 354, 356, and 358) may be communicated to a remote database and/or other devices 399 (e.g., cloud server, laptops, smartphones, other utility locator devices, transmitter devices for coupling current on utility lines, and/or other system devices) which may be processed via methods of the present invention (e.g., the method 500 of FIG. 5) in post processing or in real-time or near real-time. Still referring to FIG. 3, the utility locator device 310 may include one or more batteries 398 or other supply of electrical power in powering the various components of the utility locator device 310. In some embodiments, the one or more batteries 398 may be or share aspects with the batteries disclosed in U.S. patent application Ser. No. 16/255,524, filed Jan. 23, 2018, entitled RECHARGEABLE BATTERY PACK ONBOARD CHARGE STATE INDICATION METHODS AND APPARATUS; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. patent application Ser. No. 16/520,248, filed Jul. 23, 2019, entitled MODULAR BATTERY PACK APPARATUS, SYSTEMS, AND METHODS; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. Pat. No. 11,171,369, issued Nov. 9, 2021, entitled MODULAR BATTERY PACK APPARATUS, SYSTEMS, AND METHODS; U.S. Pat. No. 11,476,539, filed Oct. 18, 2022, entitled MODULAR BATTERY PACK APPARATUS, SYSTEMS, AND METHODS INCLUDING VIRAL DATA AND/OR CODE TRANSFER; U.S. Pat. No. 11,894,707, issued Feb. 6, 2024, entitled RECHARGEABLE BATTERY PACK ONBOARD CHARGE STATE INDICATION METHODS AND APPARATUS; and/or other devices disclosed in the incorporated patents and applications. The content of each of these applications is incorporated by reference herein in its entirety.

Turning to FIG. 4, a number of exemplary antenna arrays are illustrated which may be or share aspects with the antenna array 320 of FIG. 3 or other utility locator device embodiments of the present invention. It should be noted, a utility locator device of the present invention may include an antenna array of various configurations having different numbers of antennas. Various embodiments disclosed herein may include a dodecahedral antenna array 410 of antennas 400. In some embodiments, the antenna array may instead be an array such as an antenna array 420, an array 430, an array 440, an array 450, and array 460 having different numbers of antennas 400. Further, the embodiments of the present invention may include antenna arrays of other configurations.

Turning to FIG. 5, a method 500 is disclosed for locating and mapping utility lines. In a first step 510, the method 500 may include mapping the geolocations of electromagnetic signals measured from two or more measurement points via a utility locator device. Determining the position of the electromagnetic signals may include calculating vectors each having a direction to the electromagnetic signal source and a magnitude indicating a distance relative to the utility locator device. Calculating such vectors may be or share aspects with the methods disclosed in U.S. Pat. No. 9,207,350, issued Dec. 8, 2015, entitled BURIED OBJECT LOCATOR APPARATUS WITH SAFETY LIGHTING ARRAY; U.S. Pat. No. 10,078,149, issued Sep. 18, 2018, entitled BURIED OBJECT LOCATORS WITH DODECAHEDRAL ANTENNA NODES; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; and/or others disclosed in the incorporated patents and applications. The content of each of these applications is incorporated by reference herein in its entirety. The position of the vectors may further be mapped to the world frame.

For example, each antenna of a utility locator device of the present invention may measure a multitude of magnetic field vectors notated herein as B. In the exemplary dodecahedral antenna array of the present disclosure (e.g., the dodecahedral array 410 of antennas 400 of FIG. 4), three antennas meet at each of twenty vertices of the dodecahedron. For each vertex, the strength of field may be solved using a linear system of three equations in which each antenna has an orientation vector a and a voltage v.

$$\begin{matrix}{v}_{1} = {B}_{x} {a}_{1 x} + {B}_{y} {a}_{1 y} + {B}_{z} {a}_{1 z} \\ {v}_{2} = {B}_{x} {a}_{2 x} + {B}_{y} {a}_{2 y} + {B}_{z} {a}_{2 z} \\ {v}_{3} = {B}_{x} {a}_{3 x} + {B}_{y} {a}_{3 y} + {B}_{z} {a}_{3 z}\end{matrix}$$

For the center of the dodecahedron, the field value may correspond to the average of the vertex vectors found for all twenty vertices of the dodecahedron.

At each point in space, the magnitude of the magnetic field |\vec{B} | may be calculated by:

$$\vert \vec{B} \vert = \sqrt{{B}_{x}^{2} + {B}_{y}^{2} + {B}_{z}^{2}}$$

Each vertex also has a coordinate vector b. A dodecahedron, as in this example, has twenty vertices. Multiplying the coordinate vector by the strength of the field at the vertex yields a vector that is a component of \vec{V}|\vec{B}|, the gradient of the magnetic field magnitude. Summing all twenty of these components recovers \vec{V}|\vec{B}|. The equation describing this process to find \vec{V}|\vec{B}| is:

$$\vec{∇} \vert \vec{B} \vert = {\sum }_{i = 1}^{20} {\vec{b}}_{i} {\vert \vec{B} \vert}_{i}$$

The distance to the long conductor may then be calculated by the quotient of the magnitudes of \vec{V}|\vec{B}| and \vec{B}. The same values produce a cross-product which may provide the orientation of the conductor current I. The magnitude of the current may be calculated as:

$$I = \frac{2 π r}{{μ}_{0}} B .$$

With the values for I's orientation, distance and magnitude known, the position of the signal sources relative to the utility locator device may be determined.

An alternative process may also be used which would entail using only the voltage values at each coil v1 to v12 directly instead of the vertex calculated values. In this approach, each coil's voltage may be used directly to calculate the components of the B field and its gradient tensor G at the center of the dodecahedron. The gradient tensor of the field is a 3×3 tensor with only 5 independent components. For example, the nine components of the gradient tensor G can be written using just five components in the set {gxx, gxy, gxz, gyy, gyz} as G=((gxx, gxy, gxz), (gxy, gyy, gyz), (gxz, gyz, (−gxx −gyy))) and these values for g may be computed mathematically based on the relationships of the voltages of the coils at different faces of the dodecahedron. These tensor components may be useful for identifying tee junctions, bends, and other deviation from straight lines in buried utilities.

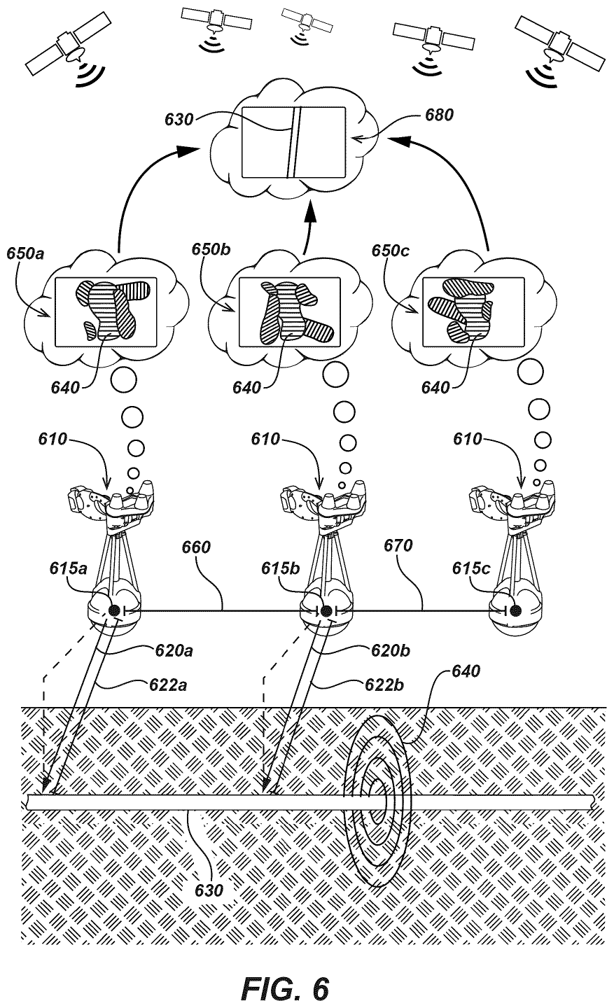

As the position of the signal sources relative to the utility locator device may be determined, mapping of signal source geolocation may further be determined where the geolocation of the utility locator device is known. For instance, a geolocation of the utility locator device may be determined via GNSS and/or other positioning element (e.g., GNNS antennas 362 and GNSS receivers 364 and/or INS 366 of the positioning element 360 of FIG. 3). The step 510 may include mapping signal source geolocation via the utility locator device at two or more measurement points. For instance, the utility locator device may be moved in space such that signals may be mapped from two or more geolocations. Such measurement points in space where the utility locator device may map signals may be referred to herein as “measurement points.” In some method embodiments, the distance between measurement points in space may be at a distance equal to or greater than the distance between measurement points in space and a utility line such as that illustrated in FIG. 6.

Still referring to FIG. 5, in an optional step 520 the method 500 may include filtering out non-spatial linear electromagnetic signal data where the magnitude of an electromagnetic signal falls beneath a predetermined threshold. For instance, weak signals may be filtered out. In another step 530, the method 500 may include filtering out electromagnetic signals that have moved spatially in the maps of electromagnetic signals measured at the different measurement points in space. In a step 540, the method 500 may include grouping electromagnetic signals based on electromagnetic signal patterns that are spatially linear. It should be noted that the linearity of mapped electromagnetic signals may not be infinitely linear but only a portion or section identified as linear. For instance, an associated utility line may include tee junctions, bends, and other deviation from straight lines in buried utilities. In another step 550, the method 500 may further include identifying utility lines where electromagnetic signals fit a cylindrical magnetic field model.

Still referring to FIG. 5, in an optional step 560, pipe Sondes and/or other dipole electromagnetic beacons may be identified and located. In another optional step 570, the method 500 may include identifying other objects in the locate environment. For instance, the step 570 may include identifying objects in the locate environment that do not move in the world frame between measurement points but emit an electromagnetic signal that is not associated with a utility line (e.g., an electromagnetic signal that is not spatially linear and/or is a dipole or other field shape that does not conform to a cylindrical field model). In some method embodiments, such objects in the locate environment may be identified by user input. In some such embodiments, the user-identified may be identified through tagging via a rangefinder apparatus (e.g., the rangefinder apparatus 715 or handheld laser rangefinder 720 of FIG. 7) or similar tagging element (e.g., the tagging element 394 of FIG. 3). In some method embodiments, such objects may be identified by various electromagnetic signal attributes or electromagnetic signature. For instance, artificial intelligence or machine learning may be used to identify objects from various signal attributes (e.g., frequencies, measurements of phase, signal shape, image recognition of objects from satellite imagery or other images at the shared geolocation, and the like).

Still referring to FIG. 5, the method 500 may include an optional step 580 displaying utility lines, pipe Sondes, and other objects in the locate environment (e.g., the map 260 of FIG. 2, the map 780 of FIG. 7, the map 860 of FIG. 8, or like display). In another optional step 590, the method 500 may include communicating data relating to utility lines, geolocations and associated electromagnetic signals, and/or pipe Sondes and/or other electronic beacons to a remote database and/or other device (e.g., the remote database/other devices 299 of FIG. 2, the remote database/other devices 399 of FIG. 3, the remote database/other devices 799 of FIG. 7, the remote database/other devices 899 of FIG. 8, or the like). The method 500 may optionally repeat mapping electromagnetic signals from additional geolocations. The method 500 may be processed on a utility locator device in real-time or near real-time.

In some method embodiments the comparison of data may occur where the distance between measurement points in space or geolocation is equal to or greater than the distance between the measurement points in space or geolocation and the position of a utility line. In FIG. 6, for instance, a utility locator device 610 is illustrated which may be or share aspects with the utility locator device 210 of FIG. 2, the utility locator device 310 of FIG. 3, and/or other utility locator devices of the present invention at various geolocation or measurement points; a measurement point 615a, a measurement point 615b, and a measurement point 615c. At a measurement point 615a, a vector 620a may be calculated in the direction to a utility line 630 having a distance measurement 622a. The locator, at the measurement point 615a may map electromagnetic signals of the locate area (e.g., an electromagnetic signal 640, 642, and 644) generating a map 650a. Likewise, at the measurement point 615b, the utility locator device 610 may determine the vector 620b having a distance measurement 622b and at the measurement point 615c, the utility locator device 610 may determine the vector 620c having a distance measurement 622c. At the measurement point 615b, the utility locator device 610 may map electromagnetic signals of the locate area (e.g., the electromagnetic signal 640, 642, and 644) generating a map 650b. At the measurement point 615c, the utility locator device 610 may map electromagnetic signals of the locate area (e.g., the electromagnetic signal 640, 642, and 644) generating a map 650c. In determining the position and mapping utility lines, such as the utility line 630, a method of the present invention (e.g., the method 500 of FIG. 5) may compare the mapping of electromagnetic signals (e.g., the map 650a, the map 650b, and the map 650c) wherein the distance measurement points in space are greater than or equal to the distance from the measurement point of the utility locator device 610 and the utility line. For instance, a distance 660 between the measurement point 615a and the measurement point 615b where the maps 650a and 650b respectively may be generated may be equal to or greater than the distance measurement 622a between the measurement point 615a and the utility line 630. Likewise, a distance 670 between the measurement point 615b and the measurement point 615c where the maps 650b and 650c respectively may be generated may be equal to or greater than the distance measurement 622b between the measurement point 615b and the utility line 630. It should be noted, the utility locator device 610 may measure electromagnetic signals a multitude of times between the measurement point 615a and the measurement point 615b as well as between the measurement point 615b and the measurement point 615c but elect to select such measurement points in generating and comparing maps of electromagnetic signals based on spacing of measurement points.

Still referring to FIG. 6, it should be noted that in each of the maps 650a, 650b, and 650c the mapped electromagnetic signal 640 does not move spatially while other signals may move. Therefore, the mapped electromagnetic signal 640 may further be evaluated (e.g., via the method 500 of FIG. 5) to determine the presence and geolocation of utility lines (e.g., the utility line 630). For instance, as the electromagnetic signal 640 conforms to a cylindrical field model and is substantially linear, it may be determined that it is associated with the utility line 630. The utility line 630 may thereby be mapped and shown on a display 680 on the utility locator device 610. It should be noted, the utility locator device 610 may likewise measure and locate other electromagnetic signals not illustrated in FIG. 6 (e.g., dipole signals such as that from pipe Sondes and/or other electromagnetic beacons).

Turning to FIG. 7, a utility locating system 700 is illustrated which may include a utility locator device 710 which may be or share aspects with the utility locator device 210 of FIG. 2, the utility locator device 310 of FIG. 3, the utility locator device 610 of FIG. 6, and/or other utility locator devices of the present invention. In the utility locator devices and associated methods of the present disclosure, other objects present in the locate environment may be mapped such as those that may emit electromagnetic signals that do not move between maps but are not linear, do not conform to a cylindrical field model, or both. For instance, the utility locator device 710 may include a laser rangefinder 715 or other tagging apparatus to identify and determine the geolocation of objects in the environment such as those which may be associated with the non-moving but non-spatially linear and/or signals that do not conform to a cylindrical field model such as an object 730 emitting a signal 740 or an object 732 emitting a signal 742. The laser rangefinder 715 may be or share aspects with the U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES and/or other devices disclosed in the incorporated patents and applications. The content of each of these applications is incorporated by reference herein in its entirety. Such a tagging apparatus may instead or additionally be a separate device such as the handheld laser rangefinder 720. The handheld laser ranger 720 may be or share aspect with U.S. Pat. No. 11,397,274, issued Jul. 26, 2022, entitled TRACKED DISTANCE MEASURING DEVICES, SYSTEMS, AND METHODS and/or other devices disclosed in the incorporated patents and applications. The content of each of these applications is incorporated by reference herein in its entirety. The mapping of one or more utility lines may be achieved via electromagnetic signals therefrom via the methods and devices disclosed herein. For instance, an electromagnetic signal 750 associated with a utility line 760 and an electromagnetic signal 752 of a utility line 762 may be measured at the utility locator device 710 from two or more measurement points in space and, via the method 500 of FIG. 5, determine the geolocation and map the utility lines 760 and 762. The utility locator device 710 may, on a display 770 or other graphical user interface, display a map 780 including the utility line 760 and 762 as well as the mapped geolocations of the objects 730 and 732. The mapping of utility lines and tagged objects (e.g., the objects 730 and 732) may be mapped in real-time or near real-time on the utility locator device 710 and/or be communicated to a remote database and/or other device 799 (e.g., cloud server, laptops, smartphones, other utility locator devices, transmitter devices for coupling current on utility lines, and/or other system devices) to map utility lines and other tagged objects. It should also be noted that other objects in the locate environment may be tagged or otherwise identified such as those which may not emit any electromagnetic signal but may be of interest or use in a utility locating operation.

As previously mentioned, a utility locator device in keeping with the present invention may locate and map pipe Sondes and/or other dipole electromagnetic beacons. Turning to FIG. 8
a utility locating system 800 is illustrated which may be or share aspects with the utility locator device 210 of FIG. 2, the utility locator device 310 of FIG. 3, the utility locator device 610 of FIG. 6, and/or other utility locator devices of the present invention. The utility locating system 800 may includes a utility locator device 810 of the present invention. As illustrated, the utility locator device 810 may measure a range of frequencies of electromagnetic signals (e.g., an electromagnetic signal 820, 822, 824, 826, and 828) present in the locate area relative to the utility locator device 810 at two or more measurement points in space (e.g., a measurement point 815a and a measurement point 815b). For instance, the utility locator device 810 may measure from 50 Hz to 148,208 Hz or other range of frequencies that may generally cover signals present in a locate environment in order to provide a reasonably complete understanding of the presence or absence and geolocations of utility lines. The utility locator device 810 may be or share aspects with the utility locator devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 29/692,937, filed May 29, 2019, entitled BURIED OBJECT LOCATOR; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; United States Patent Application D922,885, issued Jun. 22, 2021, entitled BURIED OBJECT LOCATOR; U.S. Pat. No. 11,196,181, issued Dec. 7, 2021, entitled LOW COST, HIGH PERFORMANCE SIGNAL PROCESSING IN A MAGNETIC-FIELD SENSING BURIED UTILITY LOCATOR SYSTEM; and/or others disclosed in the incorporated patents and applications. The content of each of these applications is incorporated by reference herein in its entirety.

Still referring to FIG. 8, it should be noted that the electromagnetic signals 820, 822, and 824 to a cylindrical field model whereas the electromagnetic signal 826 and 828 may be a dipole or have a different field shape. Further, it should also be noted that the electromagnetic signal 826 is illustrated as moving spatially in the world frame while the electromagnetic signals 820, 822, 824, and 828 may remain stationary in the world frame between the measurement points 815a and 815b. It should also be noted that the electromagnetic signal 828 is illustrated as emitted from a pipe Sonde 829 or, in some embodiments, a different electromagnetic beacon. The pipe Sonde may be or share aspects with those disclosed in U.S. Pat. No. 7,009,399, issued Mar. 7, 2006, entitled OMNIDIRECTIONAL SONDE AND LINE LOCATOR; U.S. Pat. No. 7,221,136, issued May 22, 2007, entitled SONDES FOR LOCATING UNDERGROUND PIPES AND CONDUITS; U.S. Pat. No. 7,298,126, issued Nov. 20, 2007, entitled SONDES FOR LOCATING UNDERGROUND PIPES AND CONDUITS; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,816, issued Mar. 3, 2009, entitled OMNIDIRECTIONAL SONDE AND LINE LOCATOR; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,864,980, issued Jan. 4, 2011, entitled SONDES FOR LOCATING UNDERGROUND PIPES AND CONDUITS; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. patent application Ser. No. 14/027,027, filed Sep. 13, 2013, entitled SONDE DEVICES INCLUDING A SECTIONAL FERRITE CORE STRUCTURE; U.S. Pat. No. 9,411,066, issued Aug. 9, 2016, entitled SONDES & METHODS FOR USE WITH BURIED LINE LOCATOR SYSTEMS; U.S. Pat. No. 9,798,033, issued Oct. 24, 2017, entitled SONDE DEVICES INCLUDING A SECTIONAL FERRITE CORE; U.S. patent application Ser. No. 16/792,047, filed Feb. 14, 2020, entitled SATELLITE AND MAGNETIC FIELD SONDE APPARATUS AND METHODS; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,761,233, issued Sep. 1, 2020, entitled SONDES AND METHODS FOR USE WITH BURIED LINE LOCATOR SYSTEMS; U.S. Pat. No. 11,119,238, issued Sep. 14, 2021, entitled SATELLITE AND MAGNETIC FIELD SONDE APPARATUS AND METHODS; U.S. Pat. No. 11,187,822, issued Nov. 30, 2021, entitled SONDE DEVICES INCLUDING A SECTIONAL FERRITE CORE STRUCTURE; U.S. patent application Ser. No. 17/563,049, filed Dec. 28, 2021, entitled SONDE DEVICES WITH A SECTIONAL FERRITE CORE; U.S. Pat. No. 11,709,289, issued Jul. 25, 2023, entitled SONDE DEVICES WITH A SECTIONAL FERRITE CORE; and/or others disclosed in the incorporated patents and applications. The content of each of these applications is incorporated by reference herein in its entirety.

Likewise, the other electromagnetic beacons may be or share aspects with the marker devices disclosed in U.S. patent application Ser. No. 15/681,250, filed Aug. 18, 2017, entitled ELECTRONIC MARKER DEVICES AND SYSTEMS; U.S. Pat. No. 9,746,572, issued Aug. 29, 2017, entitled ELECTRONIC MARKER DEVICES AND SYSTEMS; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,859,727, issued Dec. 8, 2020, entitled ELECTRONIC MARKER DEVICES AND SYSTEMS; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/541,057, filed Dec. 2, 2021, entitled COLOR-INDEPENDENT MARKER DEVICE APPARATUS, METHODS, AND SYSTEMS; U.S. Pat. No. 11,280,934, issued Mar. 22, 2022, entitled ELECTROMAGNETIC MARKER DEVICES FOR BURIED OR HIDDEN USE; U.S. Pat. No. 11,333,786, issued May 17, 2022, entitled BURIED UTILITY MARKER DEVICE, SYSTEMS, AND METHODS; U.S. Pat. No. 11,467,317, issued Oct. 11, 2022, entitled ELECTROMAGNETIC MARKER DEVICES WITH SEPARATE RECEIVE AND TRANSMIT ANTENNA ELEMENTS; and/or others disclosed in the incorporated patents and applications. The content of each of these applications is incorporated by reference herein in its entirety.

Still referring to FIG. 8, it should also be noted that in FIG. 8 the pipe Sonde 829 is illustrated as not moving between the measurement point 815a and 815b. In various applications, a pipe Sonde or other electromagnetic beacon may move between measurement points. As the pipe Sonde or other electromagnetic beacon may transmit a dipole or other electromagnetic signal at one or more known frequencies, the utility locator device may still identify, locate, and map the pipe Sonde or other electromagnetic beacon despite movement between measurement points. As such, the electromagnetic signal 826 may be excluded from being a Sonde or other electromagnetic beacon due to the particular frequency or frequencies of the electromagnetic signal 826 as measured at the utility locator device 810.

From the measured electromagnetic signals 820, 822, 824, 826, and 828 and a known geolocation determined via one or more GNSS signals 830 from a plurality of GNSS satellites 832 and/or INS (e.g., an INS 366 of FIG. 3) and/or other positioning element, a map 840a and a map 840b may be generated mapping the measured electromagnetic signals 820, 822, 824, 826, and 828 to geolocations in the world frame from each measurement point 815a and 815b respectively. For instance, the maps 840a and 840b may group each measured electromagnetic signals 820, 822, 824, 826, and 828 based on a similarity in depth measurement. In other embodiments, such a grouping may instead or additionally be based on frequency and/or other attributes of the measured electromagnetic signals. For instance, the pipe Sonde 829 may be located and mapped in the maps 840a and 840b based on emitting a known frequency or frequencies. In applications where the pipe Sonde 829 may move between measurement points 815a and 815b, the position of the pipe Sonde 829 may likewise move between the map 840a and the map 840b. The maps 840a and 840b may further be refined via the methods of the present disclosure (e.g., the method 500 of FIG. 5) in generating a map 860 indicating the geolocation of a plurality of utility lines 850, 852, and 854 and the pipe Sonde 829 in the locate area. For instance, the map 860 may result from identifying those electromagnetic signals 820, 822, and 924 from the electromagnetic signals 820, 822, 824, 826, and 828 that have not moved spatially between the maps 840a and 840b, are substantially linear in the maps 840a and 840b, and conform to a cylindrical field model. Likewise, the pipe Sonde 829, emitting one or more known frequencies may be located and mapped on the map 860.

Still referring to FIG. 8, the data relating to geolocations and associated electromagnetic signals (e.g., the electromagnetic signals 820, 822, 824, 826, and 828) may be processed via methods of the present invention (e.g., the method 500 of FIG. 5) in real-time or near real-time on the utility locator device 810. Optionally, the data relating to geolocations and associated electromagnetic signals (e.g., the electromagnetic signals 820, 822, 824, 826, and 828) may be communicated to a remote database and/or other device 899 (e.g., cloud server, laptops, smartphones, other utility locator devices, transmitter devices for coupling current on utility lines, and/or other system devices) which may be processed via methods of the present invention (e.g., the method 500 of FIG. 5) in post processing or in real-time or near real-time.

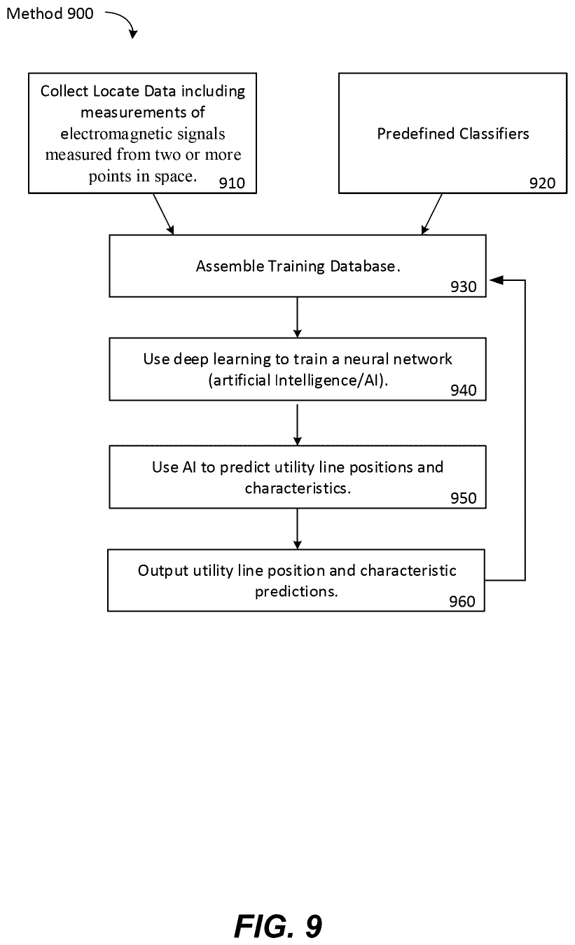

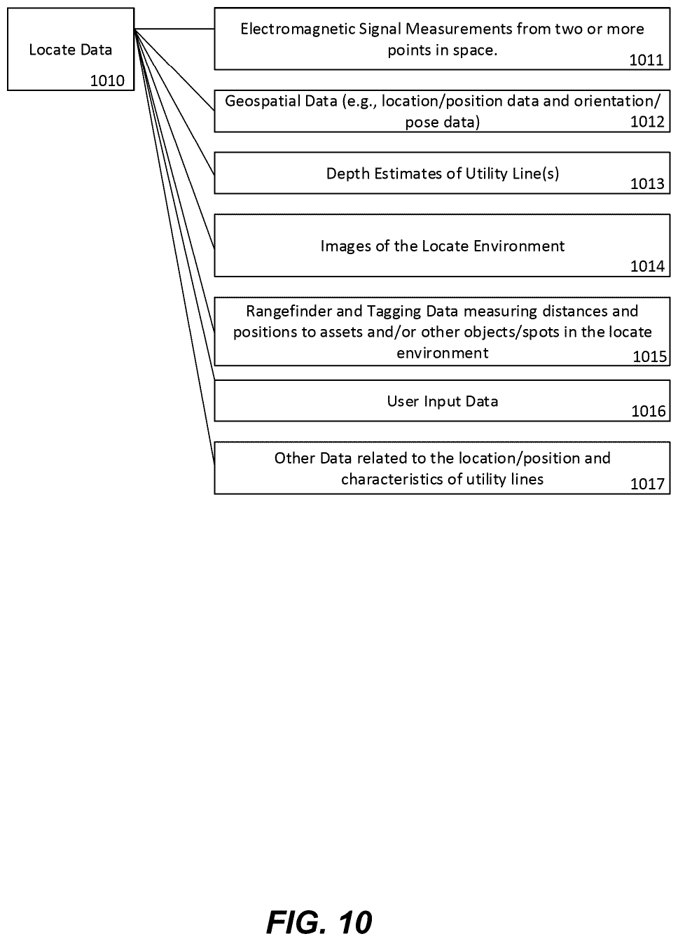

Turning to FIG. 9, a method 900 is illustrated for providing Training Data to a Neural Network to use Deep Learning/artificial intelligence (AI) to recognize patterns and make predictions related to utility lines. In a step 910, the method 900 may collect Locate Data. The Locate Data may be defined as all data relating to the locating and mapping of utility line positions that may be collected or generated by one or more utility locator devices and associated systems and devices (e.g., the system 200 of FIG. 2, the system 700 of FIG. 7, the system 800 of FIG. 8, and/or other devices and systems disclosed in the incorporated patents and applications). The Locate Data includes measurements of electromagnetic signals measured at two or more points in space. The Locate Data 910 may be or include, but is not limited to, various sources illustrated with the Locating Data 1010 of FIG. 10. In a step 920 the method 900 may include inputting one or more Predefined Classifiers (e.g., user input data or data from a pre-existing database relating to utility line positions, utility line types, depths in the ground, associated electromagnetic data, images of utility lines and surrounding environment, magnetic field models, and the like). In a step 930, the Locate Data 910 and the Predefined Classifier(s) 920 may be used in the assembly of the Training Data in a Training Database. In a step 940, deep learning may utilize the Training Data of Training Database from the step 930 to train a Neural Network (Artificial Intelligence/AI). In a step 950, AI may be used to predict utility line positions and characteristics. For instance, AI may be used to predict utility line positions and map utility lines as well as predict materials, types of utility lines, utility line depths in the ground, defects or problems in utility lines, and other characteristics. In a step 960, the method 900 may output utility line position and characteristic predictions. For instance, the predictions may be saved on one or more non-transitory memories, used to further locate utility lines, or the like. The predictions of step 960 may optionally be used in a recursive process and be added back into the Training Database of step 930.

Turning to FIG. 10, a Locate Data 1010 is disclosed which may be the same or share aspects with the Locate Data 910 showing a plurality of example sources of data that may be used to train Neural Networks. As illustrated, the Locate Data 1010 may include, but should not be limited to, electromagnetic signal measurements measured from two or more points in space. Such measurements may include measurements of electromagnetic signals emitted by one or more utility line(s), pipe Sondes, marker devices, and tracer wires as well as signals may move spatially between measurements which may be from other sources (e.g., the signal 226 and 228 of FIG. 2, the signal 326 and 328 of FIG. 3, the signal 826 of FIG. 8). The Locate Data 1010 may further include Geospatial Data (e.g., location/position data and orientation/pose data) 1012, depth estimates of utility line(s) 1013 (e.g., depth of utility lines determined via the measured electromagnetic signals), images of the locate environment 1014; Rangefinder and Tagging Data measuring the distances and positions of assets and/or other objects/spots in the locate environment 1015; User Input Data 1016; and/or other data related to the location/position and characteristics of utility lines 1017.

In some configurations, the apparatus or systems described herein may include means for implementing features or providing functions described herein. In one aspect, the aforementioned means may be a module including a processor or processors, associated memory and/or other electronics in which embodiments of the invention reside, such as to implement image and/or video signal processing, switching, transmission, or other functions to process and/or condition camera outputs, control lighting elements, control camera selection, or provide other electronic or optical functions described herein. These may be, for example, modules or apparatus residing in camera assemblies, camera and lighting assemblies, or other assemblies disposed on or within a push-cable or similar apparatus.

Those of skill in the art would understand that information and signals, such as video and/or audio signals or data, control signals, or other signals or data may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, electro-mechanical components, or combinations thereof. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative functions and circuits described in connection with the embodiments disclosed herein with respect to tools, instruments, and other described devices may be implemented or performed in one or more processing elements using elements such as a general or special purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processing elements may include hardware and/or software/firmware to implement the functions described herein in various combinations.

The previous description of the disclosed embodiments is provided to enable any person skilled in the art to make or use various embodiments. Various modifications to these embodiments will be readily apparent to those skilled in the art, and the generic principles defined herein may be applied to other embodiments without departing from the spirit or scope of the disclosure.

Accordingly, the presently claimed invention is not intended to be limited to the aspects shown herein but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the scope of the present disclosure is not intended to be limited to only the specific aspects shown herein but should be accorded the widest scope consistent with the appended claims and their equivalents.

We claim:

1. A utility locating method, comprising:
mapping the geolocations of electromagnetic signals measured from two or more points in space via a utility locator device;
filtering out electromagnetic signals that move spatially in the maps of electromagnetic signals measured at the different points in space;
grouping electromagnetic signals based on electromagnetic signal patterns that are spatially linear; and
identifying utility lines where electromagnetic signals fit a cylindrical magnetic field model.

2. The method of claim 1, further filtering out non-spatially linear electromagnetic signal data where the magnitude of an electromagnetic signal falls beneath a predetermined threshold.

3. The method of claim 1, wherein the method repeats measuring electromagnetic signals at additional geolocations.

4. The method of claim 1, wherein the distance between measurement points in space are at a distance equal to or greater than the distance between measurement points in space and a utility line.

5. The method of claim 1, wherein a pipe Sonde and/or other dipole beacon are identified and the geolocation thereof is determined by the utility locator device.

6. The method of claim 1, wherein other objects present in the locate environment are identified via user input.

7. The method of claim 1, wherein other objects present in the locate environment are tagged via a rangefinder apparatus.

8. The method of claim 1, wherein other objects present in the locate environment are identified by various electromagnetic signal attributes.

9. The method of claim 1, wherein the method is processed on a utility locator device in real-time or near real-time.

10. The method of claim 1, wherein the method is processed in a remote database.

11. A utility locator device, comprising:
one or more antennas and associated receiver circuitry to measure electromagnetic signals across a range of frequencies and determine the position of the source of the signal relative to the utility locator device;
a positioning element to determine a position of the utility locator device in the world frame;
a processing element to identify electromagnetic signals that conform to a cylindrical magnetic field model and align to be spatially linear and further remain stationary in the world frame when measured at two or more points in space in determining and mapping utility lines; and
a display element for communicating mapped utility lines to a user.

12. The device of claim 11, having twelve antennas arranged in a dodecahedral array.

13. The device of claim 11, wherein the positioning element includes one or more GNSS receivers.

14. The device of claim 11, wherein the positioning element includes one or more inertial sensors.

15. The device of claim 11, further including a rangefinder apparatus for tagging objects in the locating environment.

16. The device of claim 11, further including a radio apparatus in communicating with one or more external devices.

17. The device of claim 11, wherein data regarding mapping of utility lines determined by the utility locator device is communicated with a remote database.
